(19) United States
(12) Patent Application Publication
(10) Pub. No.: US 2009/0010202 A1
(43) Pub. Date: Jan. 8, 2009

(54) Wireless base station

(75) Inventors: Ishizaki Masayuki, Tokyo (JP); Takatani Yukihiro, Kawasaki-shi (JP)

Correspondence Address: BACON & THOMAS, PLLC, 625 SLATERS LANE, FOURTH FLOOR, ALEXANDRIA, VA, 22314-1176, US

(73) Assignee: Hitachi Kokusai Electric Inc., Tokyo (JP)

(21) Appl. No.: 11/902,091

(22) Filed: Sep. 19, 2007

(30) Foreign Application Priority Data
Sep. 27, 2006 (JP) 2006-261613
Feb. 2, 2007 (JP) 2007-024726

(51) Int. Cl. H04Q 7/00

(52) U.S. Cl. 370/328

(57) ABSTRACT

A wireless base station for mobile stations, includes a queue distributor for distributing packets among queues for a real-time system service and queues for a non-real-time system service and storing the packets; a scheduler for performing control of transmission sequence of the packets based on the queues for the real-time system service and the non-real-time system service separately; a buffer for storing the packets therein in the transmission sequence determined by the scheduler; and a mapper for allocating the packets stored at the buffer among ratio frames. Further, the scheduler uses, for the queues for the real-time system service and for the queues for the non-real-time system service, a same type of algorithm determining the transmission sequence according to priority values determined based on QoS requests and employs different equations to compute the priority values for the real time and the non-real-time system service

### FIELD OF THE INVENTION

The present invention relates to a wireless base station; and, more particularly, to a wireless base station for controlling a transmission sequence or channel allocation.

### BACKGROUND OF THE INVENTION

Conventional wireless communications base stations are proposed in Patent References 1 and 2.

As described in Patent Reference 1, recently, wireless communications system is required to be provided with multi-media service. It is considered that a suitable control providing an individual Quality of Service (hereinafter, referred to as “QoS”) for each application will be indispensable in the future. The requirement for traffic characteristics and networks specified by the QoS differs from one another depending on the type of application.

As a result, in order to satisfy the requirement for the QoS of each application using a terminal, it is considered that constructing networks and control technologies taking QoS into consideration are required.

Further, it is believed that Internet protocol (IP) may be uniformly used as the protocol for all routes between a transmission side and a reception side in the future network system.

Therefore, there is a strong possibility that the conventional wireless communications system using their own network should be changed to IP-based systems. In the IP-based system, an IP packet is a unit of the QoS control.

From this, it can be deduced that the wireless communications system needs to accept the way in which the QoS is controlled in IP communications. In a wireless communications system, since an electromagnetic wave signal is influenced by any change in transmission channel environment, interference caused by other signals and the like, reception quality at a terminal continuously varies. Therefore, special considerations different from those for the wire-line communications system are needed for the wireless communications system.

For the situation above mentioned, many control technologies regarding QoS in the wireless communications system have been proposed. In addition, for terminals that do not demand QoS, scheduling methods for determining transmission sequence while keeping fairness among terminals, and the like have been proposed.

For example, Patent Reference 1 proposes a system comprising a packet classifier configured to classify packets into a quantitative guarantee type packet having a required value for communications quality and a relative guarantee type packet having no required value for communications quality, and a transmission sequence controller configured to control a transmission sequence of the packets classified as quantitative guarantee type and those classified as relative guarantee type.

Further, there is described in Patent Reference 2 the previously mentioned communications for the case where the reception quality at the terminal varies continuously. The signals propagating through the multi-path environment such as mobile communications are affected by frequency selective fading. As a result, a phase rotation amount and received power of each sub-carrier are varied. Further, the variations differ from one another depending on a channel environment and a frequency, and frequency selectivity of a user is independent of each other. That is, there exist users having good reception channel state, SIR (Signal-to-Interference Power Ratio) for example, and users having bad reception channel state, depending on the frequencies.

For that reason, in a multi-carrier system such as an OFDM (Orthogonal Frequency Division Multiplexing) or an OFCDM (Orthogonal Frequency Code Division Multiplexing), frequency scheduling for dividing a whole frequency traffic assigned to the system into a plurality of frequency blocks and then assigning respective radio resources to divided frequency blocks is studied.

The Frequency scheduling will be described with reference to FIG. 20. In the frequency characteristics of reception channel state described in FIG. 20, the horizontal axis represents frequency and the vertical axis is for reception channel state. The horizontal axis is divided into frequency blocks 1 to 4.

Since User 1 and User 2 are in different places, they use different channels and suffer from different frequency selective fading. FIG. 20 describes a case that there is little correlation between frequency selections of User 1 and User 2.

In the case like this, a frequency traffic whose reception channel state is good to User 1, the frequency blocks 1 and 2 for example, is allocated to User 1, and a frequency traffic whose reception channel state is good to User 2, the frequency blocks 3 and 4 for example, is allocated to User 2. By the frequency scheduling like the one described above, it is possible to enhance a throughput of the whole system.

For the aforementioned, there have been proposed many control technologies for enhancing a throughput of the whole system while reception channel states are taken into consideration.

For example, Patent Reference 2 proposes that reception channel states measured by each mobile terminal are fed back to the base station, and then the base station determines frequency blocks to be allocated to respective mobile terminals based on the feedback of the reception channel states.

### [Patent Reference 1]

Japanese Patent Laid-open Application No. 2004-140604

### [Patent Reference 2]

Japanese Patent Laid-open Application No. 2006-50545

In conventional technologies, packets are divided into two groups, i.e., for a quantitative guarantee type packet having required value for communications quality and for a relative guarantee type packet having no required value for communications quality, and the quantitative guarantee type packet takes priority. However, in recent wireless communications, there are many kinds of applications (sound, image, network game, and the like) and various QoS requests, even among the packets having required value for communications quality. Therefore, classifying packets into more than two groups and elaborate control of the priority order are needed.

However, in conventional techniques, packets are classified into only two groups and some restrictions are imposed on a priority order, requiring considerable modification to remove the restrictions.

Further, in the conventional techniques, it is possible to take the receipt channel states into consideration when scheduling relative guarantee type packets is performed. However, there are some restrictions in performing control by feed backing reception channel states to a base station.

A simple explanation for the restrictions is that as the velocity of moving mobile terminal becoming faster, the relation between the measured reception channel state and the present radio channel state is becoming weakened.

Therefore, it is impossible to efficiently assign a radio resource to a terminal when the velocity of the moving mobile terminal exceeds a threshold velocity, even though MAXC/I (Maximum Carrier to Interference ratio) or PF (Proportional Fairness) is used. In case of taking the reception channel state into consideration in a wireless network with a terminal for controlling, it is necessary to further consider a velocity of the mobile terminal.

### SUMMARY OF THE INVENTION

The present invention provides a wireless base station for sending and receiving packets among mobile stations.

In accordance with an embodiment of the present invention, there is provided a wireless base station for mobile stations, including a queue distributor for distributing packets (at least) among queues for a real-time system service and queues for a non-real-time system service and storing the packets; a scheduler for performing control of transmission sequence of the packets based on the queues for the real-time system service and the non-real-time system service separately; a buffer for storing the packets therein in the transmission sequence determined by the scheduler; and a mapper for allocating the packets stored at the buffer among ratio frames.

It is preferable that the scheduler uses, for the queues for the real-time system service and for the queues for the non-real-time system service, a same type of algorithm determining the transmission sequence according to priority values determined based on QoS requests and employs different equations to compute the priority values for the real time and the non-real-time system service.

It is also preferable that the scheduler performs control of transmission sequence such that the queues for the real-time system service are sent prior to the queues for the non-real-time system service.

It is preferable that the queue distributor stores the packets separately in accordance with connection IDs at the queues and has tables for making the queues correspond to the Qos parameters including information needed to distinguish between the real-time system service and the non-real-time system service.

The scheduler may compute a different priority value for each queue depending on whether said each queue belongs to the real-time system and the non-real-time system, and wherein the priority value is expressed by adding and/or multiplying plural functions selected from a group of functions, which includes a latency function, a service class function, a quality function of wireless communications between the wireless base station and a corresponding mobile terminal, a function of an elapsed time since a previous transmission of said each queue, and a function of the number of transmissions.

The wireless base station may further include a second buffer storing packets overflown from the buffer, and the mapper classifies the packets stored in the buffer into bursts, wherein these processes are repeated until all the bursts are accepted into a radio frame by moving the packets stored in the buffer to the second buffer.

The wireless base station may further include a receiver for receiving information of wireless communications quality measured by a mobile terminal and measuring a Doppler frequency of a radio signal from the mobile terminal, wherein the scheduler controls at least one of sub-channel allocation, modulation method, and coding rate based on the information of wireless communications quality and the Doppler frequency.

In accordance with another embodiment of the present invention, there is provided a wireless base station for transmitting and receiving real-time system and non-real-time system packets to and from a plurality of subscriber stations, at an IP layer level, including: a queue distributor for distributing packets to be transmitted among plural queues and storing therein data of the packets to be transmitted; and a scheduler for computing, a scheduling priority for each queue by using different functions depending on whether said queue belongs to the real-time system or the non-real-time system and sending the queues according to magnitudes of their scheduling priorities, wherein input parameters of the functions includes a maximum latency, a minimum reserved traffic rate, a tolerable jitter amount, an elapsed time since a previous transmission, a data amount in the previous transmission, previous jitter, a modulation level, and a coding rate for said each queue.

The wireless base station may be used in an OFDMA system and may further include a mapper for classifying each of the queues of the real-time system and the non-real-time system into one of different sub-channel allocation types, and determining a data allocation while computing an amount of allocatable data into sub-channel allocation zones corresponding to a radio frame, in an order of the real-time system and the non-real time system, and also in an order of sub-channel allocation capable of adaptive modulation and sub-channel allocation incapable of adaptive modulation.

In accordance with the present invention, the number of classified packet groups, priority of each classified packet group, and a weight to each queue (SP value) are determined by a functional part such as a mapper and/or a frame creator. Thereby, the determination methods can be modified flexibly without affecting the structure of other parts and, more particularly, more precise control depending on applications can be possible. Moreover, since the SP values significantly affecting the scheduling are computed numerically from functions expressed as a table or a coefficient, optimization can be simply achieved by altering the table or the coefficient thereof.

Further, in the present invention, by considering a velocity of each mobile terminal, effective assignment of radio resources by using only reception channel with reliable state can be possible and a throughput of the whole system can be realized with high precision.

### BRIEF DESCRIPTION OF THE DRAWINGS

The above and other objects and features of the present invention will become apparent from the following description of embodiments given in conjunction with the accompanying drawings, in which:

FIG. 1 shows a configuration of a wireless base station in accordance with Embodiment 1;

FIG. 2 describes a data flow in scheduling process in accordance with Embodiment 1;

FIG. 3 illustrates an SB (Scheduling Buffer) and a Next SB in accordance with Embodiment 1;

FIG. 4 illustrates an example of burst allocation method (frequency-axis-elongated rectangle) in accordance with Embodiment 1;

FIG. 5 shows one example of burst allocation method (time-axis-elongated rectangle) in accordance with Embodiment 1;

FIG. 6 describes one example of burst allocation method (substantially square shape) in accordance with Embodiment 1;

FIG. 7 describes a burst generated by a mapper 3 in accordance with Embodiment 1;

FIG. 8 presents a timing diagram of the scheduling function in accordance with Embodiment 1;

FIG. 9 shows a data configuration of a queue management table in accordance with Embodiment 1;

FIG. 10 is a flow chart showing a schematic procedure of the main control function in accordance with Embodiment 1;

FIG. 11 is a flow chart showing a specific procedure of queue classification process in accordance with Embodiment 1;

FIG. 12 is a flow chart showing a specific procedure of connection establishment request process in accordance with Embodiment 1;

FIG. 13 is a flow chart showing a specific procedure of the connection termination request process in accordance with Embodiment 1;

FIG. 14 is a flow chart showing a specific procedure of an SS packet reception process in accordance with Embodiment 1;

FIG. 15 is a flow chart showing a schematic procedure of the frame creating function in accordance with Embodiment 1;

FIG. 16 is a flow chart showing a specific procedure of scheduling process for the real-time system in accordance with Embodiment 1;

FIG. 17 is a flow chart showing a specific procedure of scheduling process for the non-real-time system in accordance with Embodiment 1;

FIG. 18 is a flow chart showing a specific procedure of a mapping process in accordance with Embodiment 1;

FIG. 19 shows a flow chart showing a schematic procedure of the scheduling algorithm in the present embodiment in accordance with Embodiment 1;

FIG. 20 describes frequency characteristics of a reception channel;

FIG. 21 shows a flow chart showing a procedure of an SP value computing main process in accordance with an embodiment 2;

FIGS. 22A and 22B are flow charts respectively showing specific procedures of an SP values computation process in accordance with Embodiment 2;

FIG. 23 describes a flow chart showing a scheduling/mapping process procedure in accordance with Embodiment 2;

FIGS. 24A and 24B illustrates mapping of the real-time system in accordance with Embodiment 2;

FIGS. 25A and 25B illustrates mapping for the non-real-time system in accordance with Embodiment 2;

FIG. 26 shows an example of completed mapping in accordance with Embodiment 2; and

FIG. 27 is a flow chart describing a procedure of an SB control in accordance with Embodiment 2.

### DETAILED DESCRIPTION OF THE EMBODIMENTS

Hereinafter, the present invention is described with embodiments. IEE802.16 definitions are applied to all of the embodiments, and definitions of terms are based on the definitions unless specifically defined.

### Embodiment 1

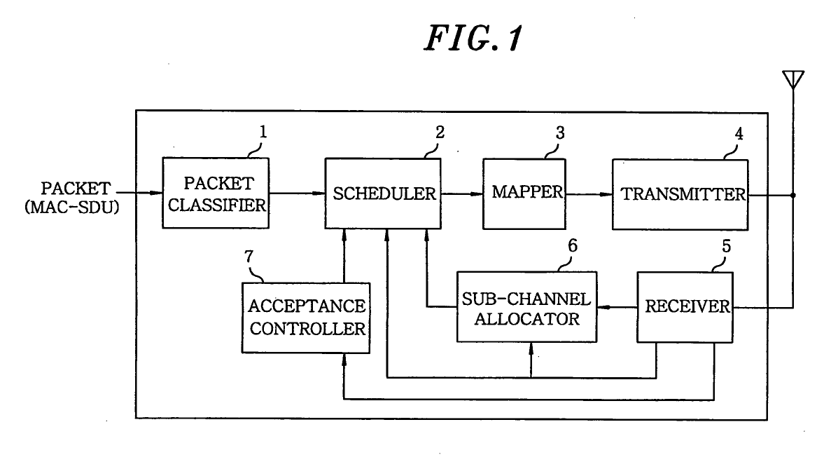

FIG. 1 shows a configuration of a wireless base station in accordance with Embodiment 1.

The wireless base station in accordance with the present embodiment includes a packet classifier 1, a scheduler 2, a mapper 3, a transmitter 4, a receiver 5, a sub-channel allocator 6, and an acceptance controller 7 and performs bi-directional wireless communications using OFDMA between a plurality of terminals not shown in FIG. 1. FIG. 1 describes a configuration corresponding to the function of MAC (Media Access Control) layer and the lower layers. Parts of an UL (Up-Link) reception system which are not needed in controlling a DL (Down-Link) transmission system are are not needed in describing the present embodiment and therefore they are omitted in FIG. 1.

The packet classifier 1 receives MAC-SDU (Media Access Control-Service Data Unit) as data to be sent and classifies thereof to store in the queues respectively provided to every CIDs (Connection Identifier) for example. A MAC-SDU is, for example, an IP packet from an upper layer.

The queue is created when a connection is initialized, and each queue has attribute values. A CID, a service type, a QoS parameter, a service class, optional information, a scheduling priority (SP), and the like is provided for attribute values.

The CID is for identifying MAC connection and has to be included in a header of MAC-PDU. The CID is, in general, different for a different service type, and can be also identified from a reception address of an upper layer (IP layer) and a port number in certain cases.

The service type is decided as UGS, rtPS, nrtPS, BE and the like according to a kind of an application.

Service classes are classified as gold, silver, and bronze, depending on the service quality.

A QoS parameter includes Maximum latency, Maximum Reserved Traffic Rate and the like. Correspondence between a service type, a service class, and a QoS parameter may be semi-fixably determined in advance.

Option information is required information for scheduling such as the number of sending/receiving, in addition to the aforementioned.

An SP value is for representing a composite priority of a queue. Scheduling is performed based on the SP value. Therefore, a method (algorithm) for determining the SP value is important.

Additional information such as CQI (Channel Quality Indicator), Fd (Doppler frequency), a modulation method, coding rate, and a sub-channel allocation may be stored as attribute values.

The scheduler 2 selects a queue classified by the packet classifier 1 based on the SP value, and retrieves data (MAC-SDU) stored in the queue to transmit the data to a scheduling buffer SB which is built-in. When the Scheduling buffer becomes full up to bytes of a capacity of one frame, the scheduling is finished and mapping is started. The process mentioned above is repeated with frame-period. The scheduler 2 receives CQI, Fd used for computing the SP values, respectively from a sub-channel allocator 6 and from a receiver 5 which are described later.

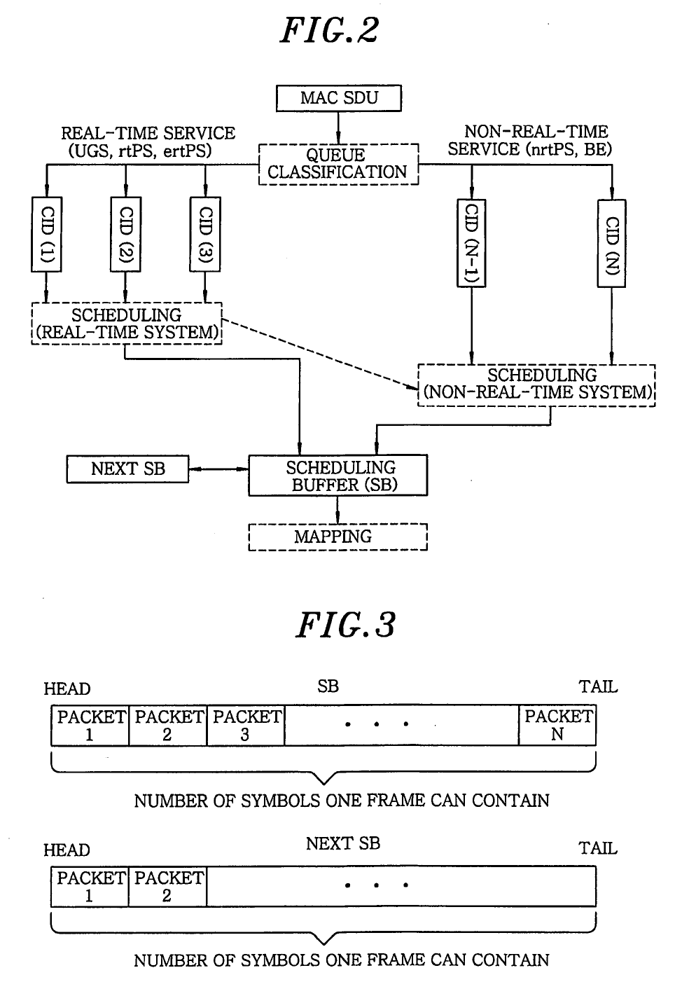

FIG. 2 illustrates a data flow in scheduling process in accordance with the present embodiment. The packet classifier classifies queues into n queues according to the CID. The scheduler 2 classifies queues broadly into a real-time system and a non-real-time system, selects target queues of scheduling respectively from the real-time system and the non-real-time system based on the SP values, which are the attribute values of the queues, (for example, in descending order of the SP values). Queues for the real-time system having a strict QoS request are transmitted to the SB first, and then queues for the non-real-time system are transmitted next.

Next SB is for storing packets overflown from the SB when all the data in the selected queues cannot be mapped at one time. The packets stored in the Next SB are transmitted via a next frame. After the packets are stored at the Next SB, the mapping is performed again. A same process is repeated until all the packets in the SB can be mapped via one frame. When the mapping is succeeded finally, the packets stored at the Next SB are copied to a header of the SB, and then are given priority to be transmitted at the first in the next frame.

FIG. 3 is an illustration of a SB and a Next SB. Moreover, the number of symbols that one frame can contain depends on the modulation method, the coding rate, the sub-channel allocation and the like, and is not fixed. The scheduler 2 (or the mapper 3) receives information such as a modulation method determined by the sub-channel allocator 6, and controls a size of the SB while transmitting the modulation method and the like to the transmitter.

Returning to FIG. 1, the mapper 3 allocates the transmission data stored in the SB (and Next SB) to the frame. Since the frame has a plurality of OFDM symbols, the transmission data can be arbitrary allocated in time-axis and in frequency-axis. However, the allocating is performed on a unit called as a burst divided as a rectangular form as described in 8.4.4. of IEEE802.16e.

As for a unit to define a burst to be allocated in a frame, three units in Table. 1 may be considered.

The first is to define one burst to one CID (Single CID-Single Burst, hereinafter referred to as SCSB). A size of each burst is reduced most and flexibility of allocation at the mapping is improved, while size of a DL-MAP message is increased most.

The second is to define one burst to one user (Single User-Single Burst, hereinafter referred to as SUSB). There are some cases one user has a plurality of CIDS. A size of each burst is reduced and flexibility of allocation at the mapping is improved, while size of a DL-MAP message is increased.

The third is to define one burst to a plurality of users with same modulation method and same coding rate en bloc. A size of each burst is increased most, flexibility of allocation at the mapping is deteriorated, but a size of a DL-MAP message is reduced most.

In the present embodiment, transmission efficiency is so important that MUSB is employed.

TABLE 1
Definition Of Burst in mapping

| | | | flexibility | |
|---|---|---|---|---|
| | burst | DL-MAP | of burst | transmission efficiency |
| | size | size | allocation | (ratio of DL-MAP in frame) |
| SCSB | small | large | ∘ | x |
| SUSB | medium | medium | Δ | Δ |
| MUSB | large | small | x | ∘ |

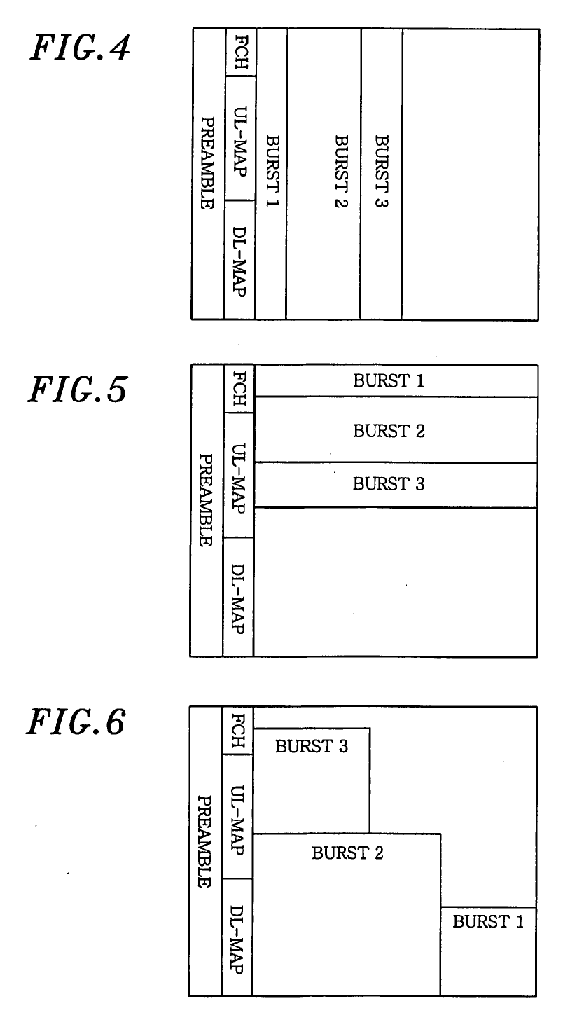

Further, burst arranging methods in the mapping are provided as follows. That is, the arrangement with a short length in direction of time axis (horizontal) and a long length in direction of frequency axis (vertical) (frequency-axis-elongated rectangle) as shown in FIG. 4, the arrangement with a long length in direction of time axis and a short length in direction of frequency axis (time-axis-elongated rectangle) as shown in FIG. 5, and the arrangement with short length in both directions of time axis and frequency axis (substantially square shape) as shown in FIG. 6. The latter, substantially square shape is complex in arrangement, so the present embodiment employs the frequency-axis-elongated rectangle or the time-axis-elongated rectangle putting emphasis on the simple mapping.

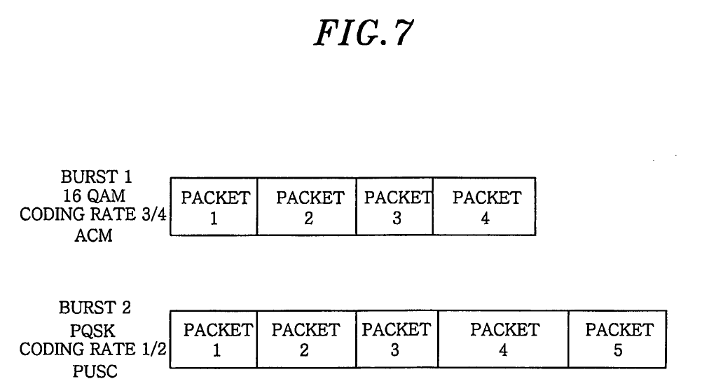

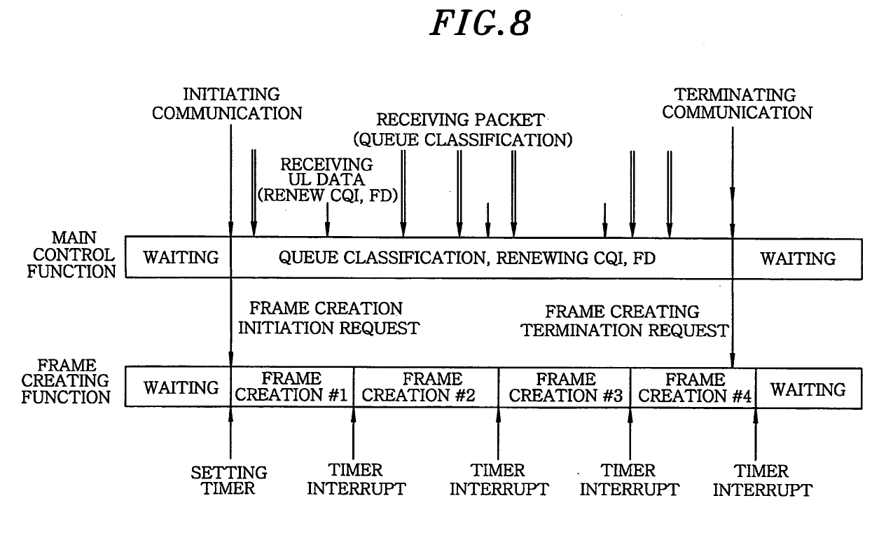

FIG. 7 shows an illustration of a burst created by the mapper 3. Even though a block size of a frame in each burst (the number of sub-channels*the number of symbols) is same, each burst capacity is different depending on the modulation method, the coding rate, and the sub-channel allocation. In FIG. 7, the block size of the burst 2 is large, and so the burst 2 capacity is also large.

Returning to FIG. 1, the transmitter 4 modulates by using the OFDM the DL frame mapped by the mapper 3 to performs radio transmission via an antenna.

The receiver 5 demodulates by using the OFDM a UL frame received from the antenna, retrieves at least CQI, Fd, and DSA-REQ (Dynamic Service Addition REQest) from a terminal, and then sends thereof to the sub-channel allocator 6, the scheduler 2, and the acceptance controller 7 respectively. Further, Fd may be computed from a phase angular velocity thereof by comparing a phase of a received pilot carrier with a known symbol, for example.

The sub-channel allocator 6 determines a modulation method, a coding rate, and a sub-channel allocation (PUSC, FUSC, PUSC w/all sub-channel and the like described later) through negotiation between terminals or based on the CQI received from the receiver, and sends thereof to the scheduler 2 and the like. The CQI represents a reception quality at the time of receiving a burst transmitted from a base station at the terminal. The CQI is promptly returned to the base station of transmission part via an exclusive channel (CQICH) provided at the UL frame. High speed feedback control depending on the channel state can be performed thereby. For example, when the CQI is poor, the sub-channel allocator 6 may switch to the modulation method or the coding rate which is robust against noise, may change the sub-channel allocation, or may (temporarily) decrease the SP value. The sub-channel allocation is modified through switching the sub-channel to an unused channel if there is any unused channel present, and switching between sub-channels with poor CQI if there is no unused channel present, for example.

Further, in case that a terminal moves at a high speed, CQI information cannot be used since a propagation path varies faster than a period of obtaining CQI. Therefore, whether or not to employ CQI is decided based on a velocity of a mobile terminal estimated from a Doppler frequency. For example, if an estimated velocity exceeds a certain threshold value, a channel state is also inferred to be poor, so a CQI in worst case (fixed value) is used, instead of CQI from the receiver 5, to fix a modulation method at the one robust to fading.

The acceptance controller 7 receives the Mac Management Message (at least DSA-REQ or DSD-REQ) from the receiver 5 and analyzes thereof to send a frame creating initiation or termination request. Additionally, a connection management or link establishment control may be performed.

Next, a scheduling algorithm of the scheduler 2, which is a characteristic of the present embodiment, will be described in detail.

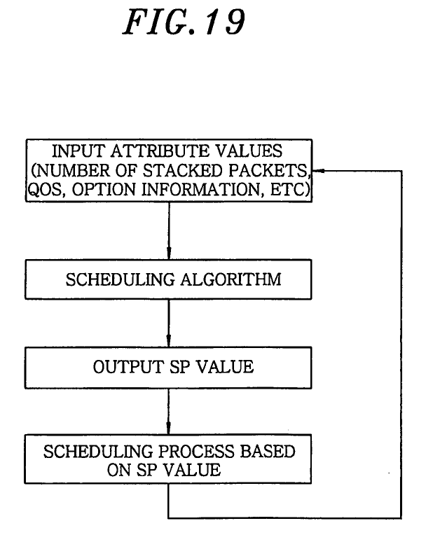

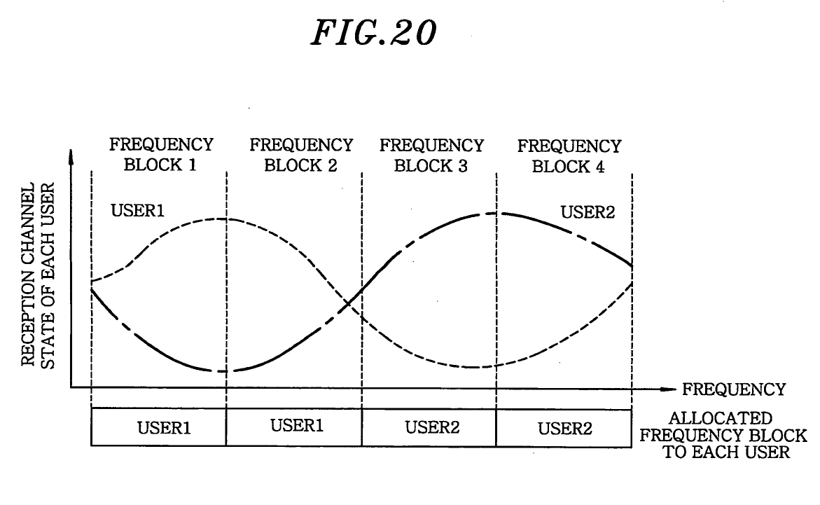

FIG. 19 is a flow chart showing a schematic procedure of the scheduling algorithm in the present embodiment. The scheduling algorithm includes a step of receiving attribute values of a queue and then computing the SP value through the algorithm, and a step of performing actual scheduling (selecting a queue) based on the computed SP value.

The SP value is a function of attribute value of each queue, and so if the attribute value of a queue is inputted to the function, the function outputs one SP value. By employing a function like the one described above, it is possible to switch the method to the one adequate to a system, to adjust parameter, or to make a whole function as a black box. Elements (arguments) for determining the SP value are considered as follows.

1. QoS parameter

2. service class

3. CQI

4. the number of (or the size of) packets stacked in a queue

5. the time of previous packet transmission (elapsed time since previous transmission)

6. the number of packet transmissions by the present time

7. and so forth.

Among the elements, non-numerical elements (service class and the like) which are not expressed numerically are assigned with corresponding numerical values by a table. Elements expressed by numerical values are normalized by a linear transformation or a upper/lower limit. If the normalized values of m elements for computing the SP value are F1, F2, . . . , Fm respectively, the SP values are computed by addition/subtraction of Fn, multiplication/division of Fn, or a combination thereof, as shown below, for example.

SP=F1+F2+F3+ . . . +Fn

OR

SP=F1*F2*F3* . . . *Fn Eq. 1

Further, not all the elements may be used as a input of the function. In the present embodiment, every element is converted to a numerical value, so an equation for computing the SP value can be flexibly modified in accordance with system demand. In case of elements having varying values, not only present values but also past values can be used for normalization.

As aforementioned, the scheduler 2 performs the scheduling on the real-time system and the non-real-time system, by broadly classifying. Different algorithms, i.e., different functions of a SP value are used in the real-time system and the non-real-time system. For example, at the real-time system, the SP value is computed by weighting QoS parameters among the attribute values. Meanwhile, at the non-real-time system, the SP value is computed by weighting fairness (the number of transmissions) among the attribute values. In any case, if the CQI is available, the SP value is computed by taking the CQI into consideration.

Hereinafter, operation of a base station in accordance with the present invention will be described in detail. Scheduling functions in following description are not limited to the functions of the scheduler 2 but include functions of other units such as the packet classifier 1. Moreover, it is presumed that they are performed by software.

FIG. 8 presents a timing diagram of the scheduling function in accordance with the present embodiment. The scheduling function in the present embodiment includes a main control function and a frame creating function.

The main control function is to perform main tasks and perform processes in response of needs from various events. Specifically, there are connection initialization (creating queue), control of the queue management table, and determination of a modulation method, a coding rate, and sub-channel allocation based on a packet reception, the queue classification, and the CQI received from the terminal. The main control functions correspond to the functions of the packet classifier 1, the sub-channel allocator 6, and the acceptance controller 7.

The frame creating function is called from the main function and performs a periodical frame creating process, scheduling (real-time system, non-real-time system) process, or mapping process. The frame creating process is initiated when a frame creating initiation request is received from the main controller and finished when a frame creating Stop request is received. The frame creating function corresponds to the functions of the scheduler 2 and the mapper 3.

In FIG. 8, the main control function instructs frame creating initiation request to the frame creating function when receiving a DL packet (MAC-SDU) from an upper layer for the first time since operating, or when receiving DSA-REQ from the terminal. The frame creating function receiving thereof sets a timer, and generates a frame through scheduling and mapping, by using periodical timer interrupt as a trigger thereafter. Further, the main controller performs a queue classification process when receiving the DL packet (MAC-SDU) from the upper layer, and renews a CQI and Fd of each terminal to determine a modulation method, a coding rate, and sub-channel allocation when receiving the UL data from terminals. Further, when receiving a DSD-REQ (Dynamic Service deletion REQuest) of the last (the only) connection remaining in the queue management table, the main control function sends a frame creating termination request to the frame creating function. After the frame creating function completes creating the last frame, both functions are put on a waiting state.

Further, the DSA-REQ and DSD-REQ are a kind of a Mac Management Message contained in a MAC-PDU (Protocol Data Unit) and written in IEEE802.16-2004 6.3.2.3.10 and 6.3.2.16 respectively.

Queue management for every connection by the main control function is performed by using a queue management table.

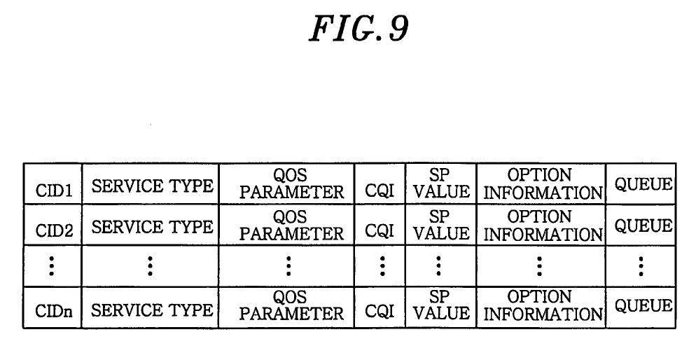

FIG. 9 shows a data structure of a queue management table. The table stores therein various attribute values, SP values, and (a pointer of) stacked packet with the CID as a key. The table is also accessed by the frame creating function to renew the SP value for example.

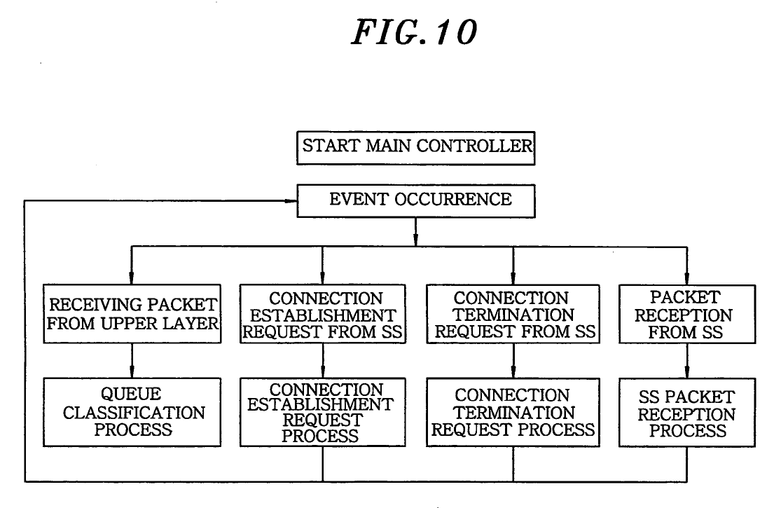

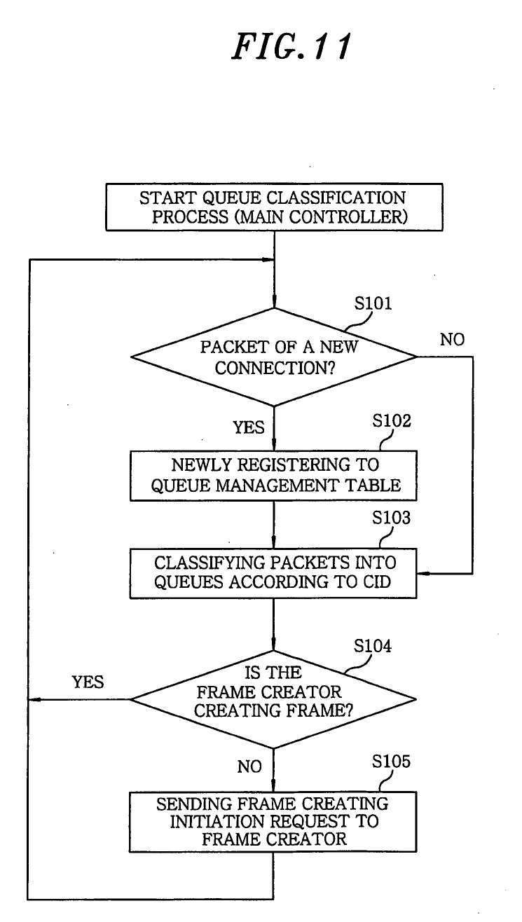

FIG. 10 is a flow chart showing a schematic procedure of the main control function. The main control function performs at least four processes depending on the kinds of packets or messages received from an exterior. That is, queue distribution process, connection establishment request process, connection termination request process, SS packet reception process. The four processes mentioned above are nothing but examples needed to describe the present embodiment, and they are not all process. An internal event may be occurred from a certain process and an additional process may be called.

FIG. 11 is a flow chart showing a specific procedure of a queue classification process. The queue distribution process classifies packets received from an upper layer into queues (S103). Before that, whether or not the packet is a new connection is determined (S101). If the packet is a new connection, a new registration to the queue management table is executed to create a new queue (S102). Further, if the frame creator is not in the regular frame creating operation state (S104), the frame creating initiation request is sent to the frame creator (S105). After completing thereof, the procedure is returned to a waiting state.

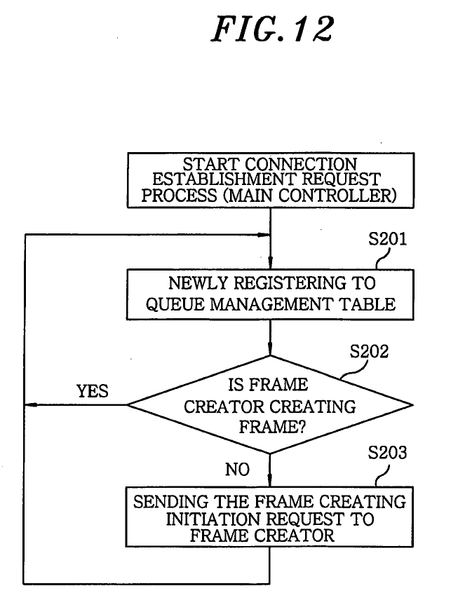

FIG. 12 is a flow chart showing a specific procedure of a connection establishment request process. The connection establishment request process is executed when receiving a connection establishment request from a terminal (SS: Subscriber Station) for example. To begin with, new registration to the queue management table is executed and a traffic rate request is reflected on the queue management table (S201). At this time, if the total sum of the traffic rate request amount in each connection exceeds the capacity of a corresponding wireless base station, there is no new registration and no respond to the DSA-REQ. Further, whether the frame creator is in the state of a regular frame creating operation is detected (S202), and the frame creating initiation request is sent to the frame creator if the frame creator is not in the operation (S203).

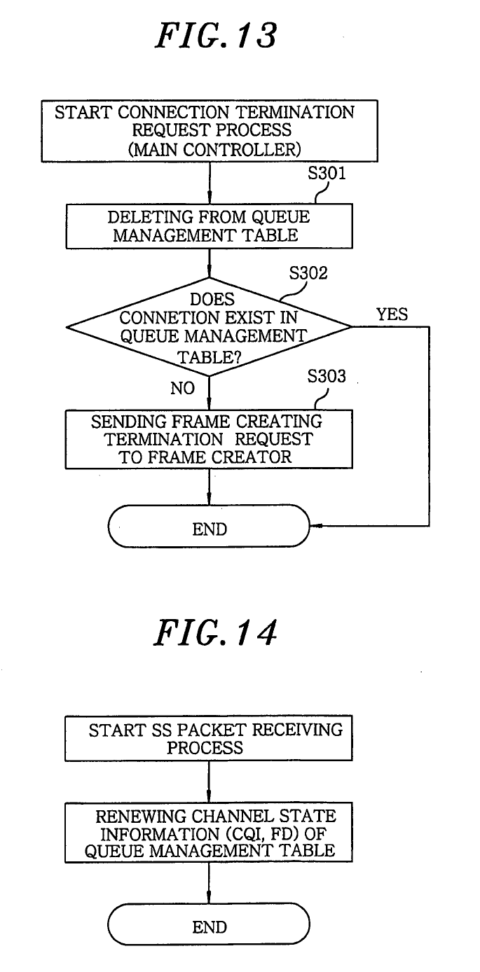

FIG. 13 is a flow chart showing a specific procedure of the connection termination request process. The connection termination request process is performed when receiving a connection termination request from a terminal SS. To begin with, a corresponding queue is deleted from the queue management table, the memory is freed (S301). Next, whether or not there is a connection in the course of communications present in the queue management table (whether a target connection for scheduling exists) is detected (S302). If there is none present, the frame creating termination request is sent to the frame creator (S303).

FIG. 14 is a flow chart showing a specific procedure of an SS packet reception process. The SS packet reception process is performed when receiving UP-Link data from a terminal SS. The CQI is obtained through modulation of the CQICH while Fd (Doppler Frequency) information is obtained from a physical layer to renew the CQI and the Fd information on the queue management table.

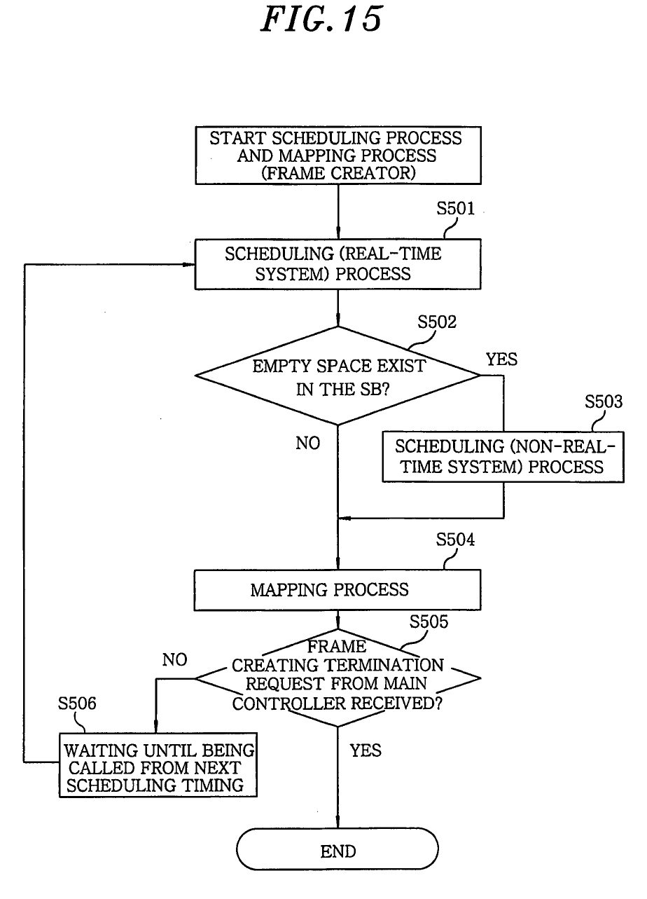

FIG. 15 is a flow chart showing a schematic procedure of the frame creating function. The process of the frame creating function is performed at a frame period interval through timer interrupt. To begin with, a scheduling process for the real-time system is performed (S501) for the first time. Next, whether or not there is an empty space present in the SB is checked (S502). If there exists an empty space, a scheduling process for the non-real-time system is performed (S503). A mapping process is performed thereafter (S504). After then, whether a frame creating termination request is received from the main controller is checked (S505). If there is no frame creating termination request, the process is waiting till being called from next scheduling timing (S506).

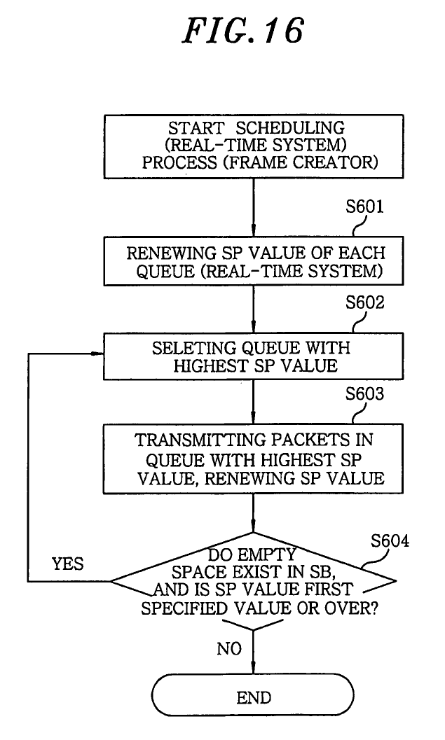

FIG. 16 is a flow chart explaining a specific procedure of scheduling process for the real-time system. In the scheduling process for the real-time system, at first, the SP value of each queue for the real-time system is renewed through the function of the SP value aforementioned (S601). When it is ascertained that the service type in the queue management table is among UGS, rtPS, or etrPS, the queue is identified as the real-time system. Next, a queue with the highest SP value is selected (S602), the packets in the queue are transmitted to the SB, and at the same time, the SP value of the queue is renewed (S603). It is for the reason that at least the number of the packets stacked in the queue is altered (to “0”) accompanying with transmission of the packets from the queue, and so it would be impossible to properly select a next queue unless correcting it with prompt reflection thereof. At this time, the CQI renewed at the latest SS packet reception process is also added thereto. Next, whether there are empty spaces in the SB and whether queues with the SP value of equal to or larger than the first specific value present are detected (S604). In case of present thereof, the procedure is returned to S602. Through this process, selecting a queue is repeated until there is no empty spot in the SB or every SP value of every queue is less than the first specific value. There is some probability that the queue with the SP value equal to or larger than the first specific value overflow into the Next queue, but the overflow rarely occurs since the total amount of a connected traffic has a limit.

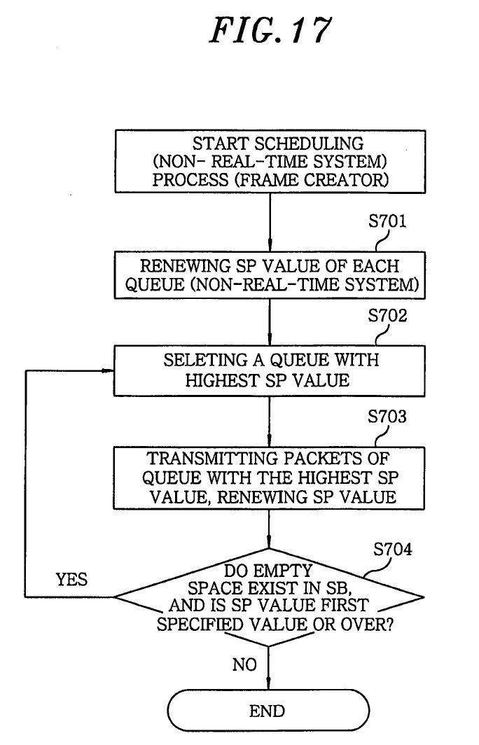

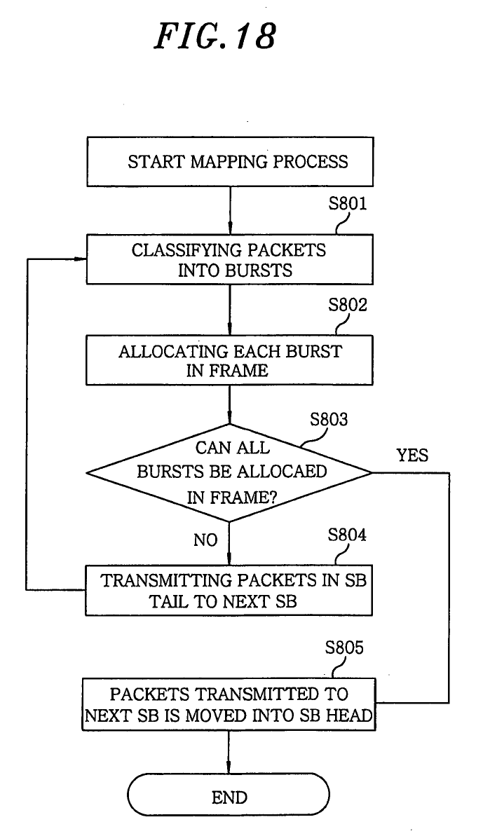

FIG. 17 is a flow chart showing a specific procedure of a scheduling process for the non-real-time system. Every step is equal to the one of the scheduling process for the real-time system, excepting that a target of scheduling is a queue for the non-real-time system (whose service type is nrtPS or BE), the SP value function is for the non-real-time system, and the second specific value is used instead of the first specific value.

FIG. 18 is a flow chart showing a specific procedure of a mapping process. In the mapping process, at first, packets (MAC-SUD) in the SB are classified into bursts having same modulation method, same coding rate, and same sub-channel allocation (S801). Next, each burst is allocated (mapping) in the frame (S802). After that, whether or not all the bursts could be allocated in the frame is confirmed (S803). If not all the bursts could be allocated in the frame, the packets in SB tail (having lowest priority among the packets in the SB) are moved to the Next SB (S804), and the procedure is returned to S801. Through this process, burst classification and mapping are performed once more, and repeated till all the bursts can be allocated in the frames. When the burst can be allocated in the frame, the packet which has been moved to the Next SB is transmitted to SB head after mapping of the present frame is finished (S805). Through the process above, the packet takes the priority to be transmitted first of all at the time of creating a next frame. Further, in the repeated mapping process, actual data may not be repeatedly written in memory. Instead, the mapping process may be carried out logically.

In the present embodiment, respective scheduling of the real-time system and the non-real-time system use a same algorithm except for the function of the SP value, and the SP value is a function of elements on a common queue management table. Therefore, at the time of classifying queues, there is no need of different processes in respective schedulings. That is, functions of packet classification (queue distribution) and functions of scheduling are separated completely.

In the present embodiment, queues are provided to every CID considered as a minimum unit for distinguishing QoS request (SP value). However, queues may be provided in any ways if queues can be classified into the number of groups equal to or greater than the number of scheduling to be properly distributed to proper schedulings.

Moreover, not the number of schedulings is restricted to two, e.g., the real-time system and the non-real-time system, but methods or the number of distributions can be altered flexibly depending on which the distribution is based among various elements on the table since various elements in addition to the service type are stored on the queue management table.

Further, in the present invention, through using the SP value, proper scheduling with consideration of not only a specific QoS parameter, e.g., the Maximum latency, but also other various elements is possible.

### Embodiment 2

In Embodiment 2, an algorithm for computing the SP value will be specifically described. Further, a specific method of dividing a frame into a plurality of zones and using AMC (Adaptive Modulation and Coding) founded on high-speed feedback will be described. Elements not mentioned in the present embodiment are equivalent to the elements of embodiment 1, but the present embodiment does not restrict in any way that of Embodiment 1.

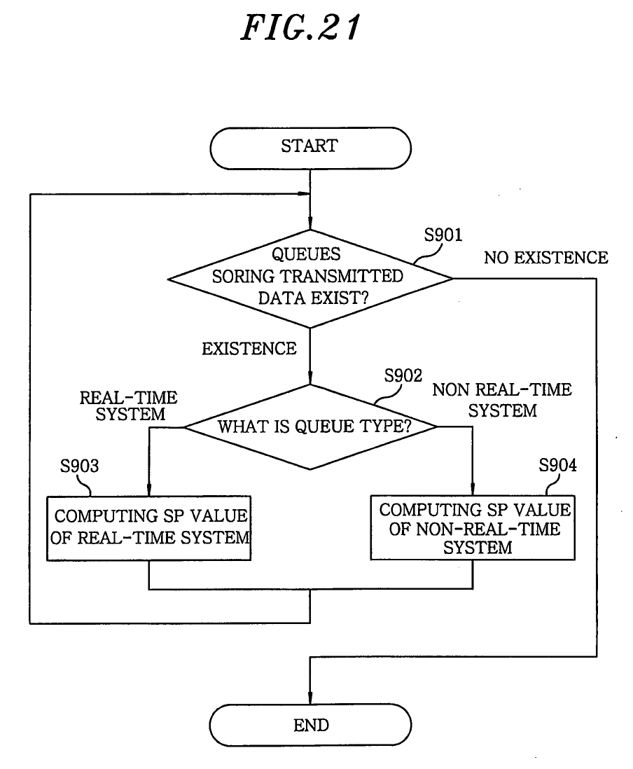

FIG. 21 is a flow chart showing SP value in the base station in accordance with Embodiment 2. The main process for computing the SP value is performed at a frame period interval, starting from the event waiting state shown in FIG. 10 for example.

To begin with, whether or not there are queues storing transmitted (and unprocessed) data present is confirmed. If there are, one of the corresponding queues is selected and following process is performed thereon. If there is none present (if all the SP value computation of queues storing transmitted data is completed), the main process for computing the SP value is finished (S901).

Next, whether the selected queue is a type for the real-time system or a type for the non-real-time system is ascertained, and the selected queue is distributed to a corresponding algorithm (S902).

Next, the SP value of the distributed queue is computed in an SP value computation process for the real-time system (S903) or an SP value computation process for the non-real-time system (S904). After that, the procedure is returned to S901 and then same procedure of the process is repeated on the other remaining queues.

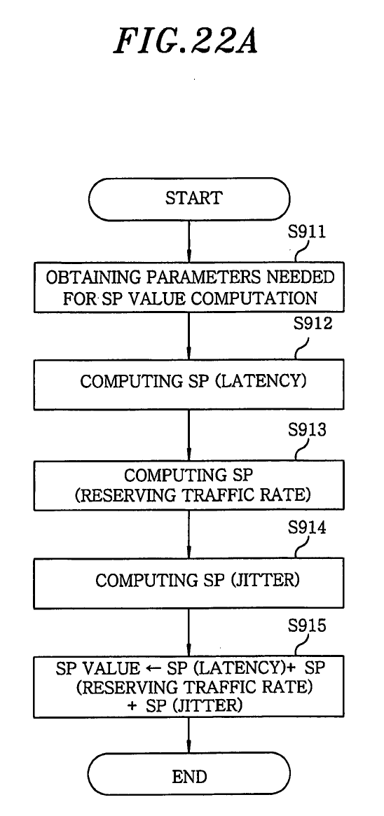

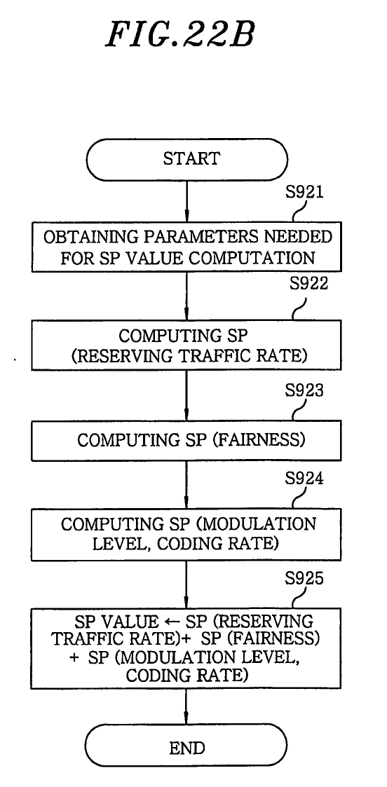

FIGS. 22 A and B are flow charts respectively showing specific procedures of SP value computation processes.

FIG. 22 A is a flow chart showing a specific procedure of an SP value computation process for the real-time system. To begin with, parameters needed for computation (latency, reserved traffic rate, jitter) are obtained from the queue management table in FIG. 9 (S911). Then, the SP for the latency is computed (S912), then the SP for the reserved traffic rate is computed (S913), and finally the SP for the jitter is computed (S914). The three SP values mentioned above are added together and the result is decided to be the SP value of a corresponding queue (S915). This renewed SP value is properly stored on the queue management table.

FIG. 22 B is a flow chart showing a specific procedure of an SP value computation process for the non-real-time system. The procedure is carried out in a same manner as in the real-time system. Parameters (reserved traffic rate, fairness, modulation level, coding rate) are obtained (S921), and then the SP for the reserved traffic rate is computed (S922), the SP for the fairness is computed (S923), and the SP for the modulation level is computed (S924). The SP values mentioned above are added together and the result is decided to be the SP value for the corresponding queue (S925). Since parameters such as a modulation level are adaptively controlled by AMC, they can be obtained from a unit for attaining the function such as the sub-channel allocator 6.

Next, the SP computation algorithm shown in FIG. 22 A will be described.

Parameters in Table 2 below are required in computing the real-time system SP value (S903). Further, three QoS parameters are specified for respective service flows. The service flows are defined in IEEE802.16e-2005 6.3.14.2.

TABLE 2

| item | Description |
|---|---|
| QoS | Maximum latency (sec) |
| parameters | Minimum reserved traffic rate (bps) |
| | Tolerated jitter(sec) |
| other | elapsed time since previous transmission (sec) |
| parameters | amount of previous transmission data (bit) |
| | previous jitter (sec) |

The SP value for the latency in S912 can be expressed as follows when a maximum latency is d (sec), an elapsed time since previous transmission is t (sec), and a constant value is α:

$$α \times \frac{1}{d - t} . \qquad Eq . 2$$

As the elapsed time since a previous transmission becomes close to the maximum latency, the SP value is increased.

The SP value for the reserved traffic rate in S913 can be expressed as follows when a minimum reserved traffic rate is r(bps), an elapsed time since previous transmission is t(sec), the data amount in the previous transmission is 1 (bit), and a constant value is β:

$$β \times \frac{r}{\frac{l}{t}} . \qquad Eq . 3$$

An intimate transmission rate is computed from the elapsed time since the previous transmission and the amount of previous transmission data. As the computed value becomes getting smaller, the SP value becomes increased.

The SP value for the jitter in S914 is expressed as follows when an elapsed time since the previous transmission is t(sec), a previous jitter is t′ (sec), and a constant value is γ:

γ×(t−t′) Eq. 4.

Here, an initial value of t′ is given as a Tolerated jitter (sec). When the elapsed time since the previous transmission is smaller than the previous jitter, the SP value is negative. As the elapsed time since the previous transmission is increased to be larger than the previous jitter, the SP value is increased and becomes positive.

Next, the SP computation algorithm shown in FIG. 22 B will be described.

The parameters in Table 3 below are required in computing the non-real-time system SP value (S904). Since the QoS parameters are specified for respective service flows, they are different from the ones for the real-time system in general.

TABLE 3

| item | Description |
|---|---|
| QoS | Minimum reserved traffic rate (bps) |
| parameters | |
| other | elapsed time since previous transmission (sec) |
| parameters | amount of previous transmission data (bit) |
| | modulation level |
| | previous jitter (sec) |

The SP value for the reserved traffic rate in S922 can be expressed as follows, equivalent to the equation for the real-time system when the minimum reserved traffic rate is r (bps), an elapsed time since the previous transmission is t (sec), the data amount in the previous transmission is 1 (bit), and a constant value is x:

$$x \times \frac{r}{\frac{l}{t}} \qquad Eq . 5$$

The SP value for the fairness in S923 can expressed as follows when the elapsed time since the previous transmission is t (sec) and a threshold of the elapsed time since the previous transmission is tₜₕᵣₑₛ (sec)

t<tₜₕᵣₑₛ 1

t>tₜₕᵣₑₛ ∞ Eq. 6.

If the elapsed time since the previous transmission exceeds the threshold, scheduling thereof takes priority to be performed.

The SP value for the fairness in S923 is expressed as follows when modulation level is g, the coding rate is h, and a constant is y:

y×(g×h) Eq. 7.

Through this equation, the SP value can be computed with weighted modulation level and weighted coding rate. Fundamentally, a queue for a user who is capable of transmitting at a high coding rate has a high SP value.

As mentioned above, after classifying data streams into the real-time system and the non-real-time system, a plurality of parameters are combined into a single SP value through the SP computation algorithm, so that priorities of a queue is unified into a single total priority and selecting a queue in order to control transmission sequence can be performed simply by comparing SP values. Moreover, QoS of every data stream can be satisfied.

Next, a scheduling and mapping process which is another characteristic of Embodiment 2 will be described. In the present embodiment, the latency characteristics of the data of the real-time system are guaranteed while data of the real-time system and data of the non-real-time system are mapped into AMC zone.

In IEEE Std.802.16-2004, an AMC, a sub-channel allocation (sub-carrier allocation) such as a PUSC (Partial usage of Sub-channels), a FUSC (Full Usage of Sub-channel) or a PUSC w/all sub-channels, and applying one or more of the sub-channel allocation to corresponding one or more region (zone) in a frame are defined.

In the present embodiment, in order to perform mapping on an AMC zone, it is possible to divide the SB such that the divided SBs can be allocated to respective users and/or respective sub-channel allocations.

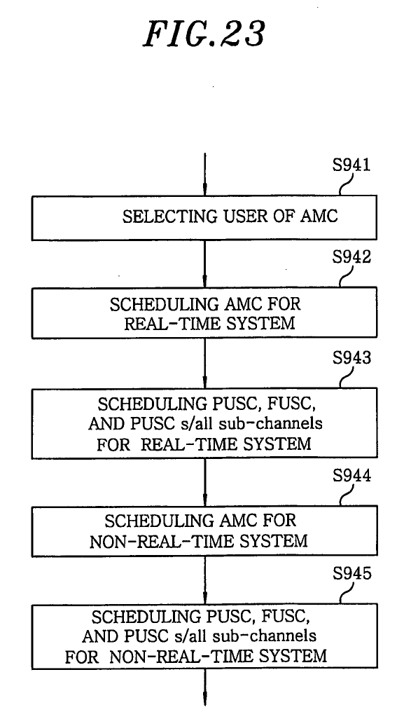

FIG. 23 is a flow chart showing a scheduling/mapping process procedure of the present embodiment. FIG. 23 corresponds to FIG. 15 of Embodiment 1 and the process thereof uses the means in FIG. 1 such as the scheduler 2 and the mapper 3.

The scheduling/mapping process in the present embodiment carries out selecting a user of the AMC (S941), scheduling the AMC for the real-time system (S942), scheduling the PUSC, FUSC, and PUSC w/all sub-channels for the real-time system (S943), scheduling the AMC for the non-real-time system (S944), and scheduling the PUSC, FUSC, and PUSC w/all sub-channels for the non-real-time system (S945).

In Embodiment 1, the processes for the real-time system take priority to be performed as shown in FIG. 2. However, in the present embodiment, the scheduling is performed on each zone both for the real-time system and for the non-real-time system.

That is, the AMC has higher transmission efficiency than the PUSC since the modulation method and the coding rate of a burst are determined based on the CQI received from each terminal. Therefore, an AMC zone takes priority over a PUSC zone in performing the process and a broad zone is secured for the AMC.

Further, as will be described later, scheduling processes of each QoS category in the real-time system (UGS, ertPS, rtPS) and the non-real-time system (nrtPS, BE) can be arranged in order.

In the present embodiment, since mapping is logically performed at scheduling of every zone and the scheduling and the mapping proceed integrally, both processes will be called as mapping/scheduling instead of distinguishing one from the other.

Further, although in the description of the SB, only a single SB is used in the aforementioned description of the SB, there is needed a plurality of SB in the present embodiment since the present specific description is for a case where there is a plurality of mapping zones involved. However, even though the number of the SBes is increased, a control method is same as the case where there is only a single SB involved.

In selecting a user of an AMC (S941), following classification is performed based on a synchronous state and a velocity of each SS. Specifically, the synchronous state of each SS is examined at first, and then, any SS not in a synchronous state is excluded from scheduling. Next, a velocity Fd of each SS is examined. Any SS of which velocity exceeds a specified value is allocated to the PUSC, FUSC, PUSC w/all sub-channel (SS excluded from AMC) and AMC is applied to the other SSes.

In a next AMC scheduling for the real-time system, a burst is assigned to the sub-channel based on the CQI of each SS.

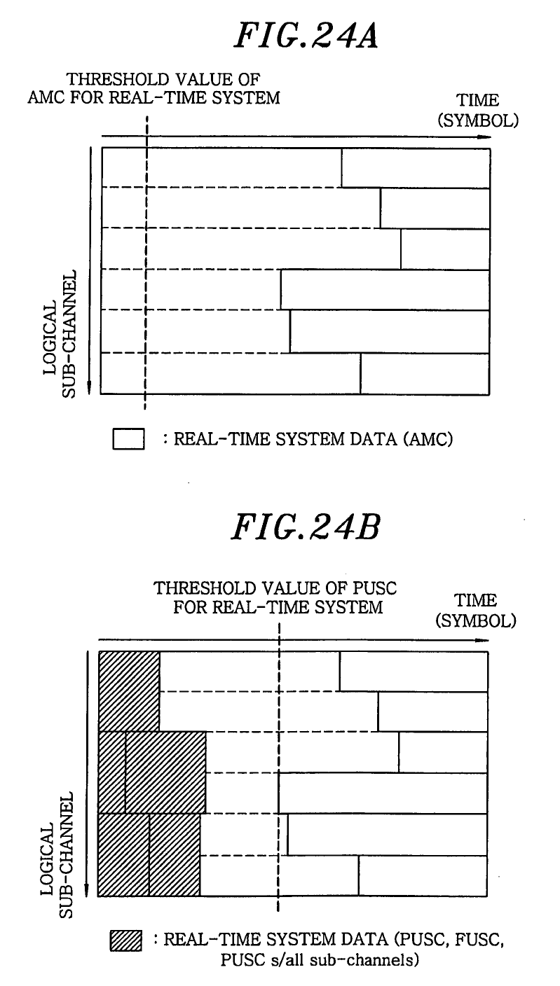

FIG. 24A is an example of the mapping for the real-time system AMC.

To begin with, in S951, one sub-channel is allocated to each SS, wherein the allocated sub-channel is selected in the order of good CQI at Maximum reserved traffic rate (or sum thereof in case of a plurality of service flow existence) based on CQI. The allocated sub-channel was used in the previous frame where the good CQI was obtained. In case where there is a plurality of SS that uses a same sub-channel, the SS having lower CQI is assigned to the last remaining sub-channel for example.

However, if there are small number of users, and if different modulation methods and different coding rates are available to a series of sub-channels, the SSes may use the series of sub-channels.

After that, a real-time system scheduling of SS for the AMC is performed on each SS. Therefore, a burst is distinguished by SUSB in general.

To begin with, in S952, a threshold value is set to provide an upper limit of a width of an AMC zone. Since a head of a frame is defined to start from a PUSC zone, in order to reserve the PUSC zone, a temporal AMC zone is provided at a tail of the frame by backward packing it and a head of the temporal AMC zone corresponds to the threshold value of the real-time system AMC. The threshold value of the real-time system AMC may be determined based on a ratio of a total SP value sum of the real-time system to that of the non-real-time system.

Next, a maximum amount of transmittable data in an allocated region of an SS in a frame is computed for each corresponding SS from a modulation method, a coding rate, a threshold value (and the number of sub-channels) of the real-time system AMC (S952). The maximum amount of the data is decided to be an SB size for each AMC user.

Next, in S953, scheduling is performed on among queues which are of SS for the AMC and belong to the first priority QoS category (UGS) in the real-time system, in descending order of the SP values, and transmitted data is sent to an SB established for each user.

Next, in S954, scheduling is performed on among queues which are of SS for the AMC and belong to the second priority QoS category (ertPS) in the real-time system, in descending order of the SP values, and transmitted data is sent to the SB established for each user.

Next, in S955, scheduling is performed on among queues which are of SS for the AMC and belong to the third priority QoS category (rtPS) in the real-time system, in descending order of the SP values, and transmitted data is sent to the SB established for each user.

After the scheduling is finished, in S956, a maximum number of symbols in the AMC zone (provisional) is computed from data amount stored at the SB allocated to each user.

Returning to FIG. 23, next in scheduling of the real-time system PUSC, FUSC, PUSC w/all sub-channels, a sequential burst allocation performed starting from the head of the frame.

FIG. 24B is an example of mapping the real-time system PUSC.

To begin with, in S961, the maximum number of symbols in the PUSC zone is determined from the maximum number of symbols in the AMC zone, computed in S956. The maximum number of symbols in the PUSC zone is (maximum number of symbols in Down-link−maximum number of symbols used for real-time system bursts of SS for the AMC). However, if there is an SS for the FUSC or PUSC w/ all sub-channels, the maximum number of symbols in the PUSC zone is decided so as to ensure the FUSC zone and PUSC w/ all sub-channels zone. For example, users are classified into a PUSC user, a FUSC user, and a PUSC w/ all sub-channel user the and SP values of respective classified users are summed up so that the maximum number of the PUSC zone symbols is determined based on ratios of the respective sums.

Next, in S962, a size of the SB for the PUSC zone (equivalent to a limit of data amount whose mapping is available on the PUSC zone) is computed from the maximum number of the PUSC zone symbols. At this time, the size of the SB for the PUSC zone is decided by a rough estimate since modulation methods and coding rates differ from one user to another user.

Next at S963, bursts (FCH, DL-MAP, UL-MAP) needed to be inserted to the PUSC are assigned.

Next, in S964, scheduling is performed among queues which are of SS for the PUSC and belong to the first priority QoS category (rtPS) in the real-time system, in descending order of the SP values, and transmitted data is sent to an SB for a PUSC. Further, an SS for AMC already assigned at the time of scheduling of the previous real-time system AMC is excluded from the SS for the PUSC.

Next, in S965, scheduling is performed on among queues which are of SS for the PUSC and belong to the second priority QoS category in the real-time system, in a descending order of the SP values, and transmitted data is sent to the SB for the PUSC.

Next, in S966, scheduling is performed on among queues which are of SS for the PUSC and belong to the third priority QoS category in the real-time system, in the order of descending of the SP values, and transmitted data is sent to the SB for the PUSC.

After the scheduling is finished, in S967, the number of symbols to be used is computed from the data amount stored at the SB for the PUSC and the maximum number of the symbols in the PUSC zone is determined. In the PUSC zone, any burst among the SCSB, SUSB, MUSB can be used and dividing SB to every user is unnecessary. However, the maximum number of symbols in the PUSC zone cannot be recognized without a burst allocation to the PUSC zone, and so it is necessary to complete logical mapping before then. Therefore, in FIG. 24B, the number of symbols in a sub-channel using the most symbols is the maximum number of symbols in the PUSC zone.

Next, in S968, if process for FUSC or PUSC w/all sub-channel is necessary, the process equivalent to the one aforementioned is performed on each zone.

Finally in S969, the number of symbols in every zone of the PUSC, FUSC, PUSC w/all sub-channels is computed.

Returning to FIG. 23, in a next scheduling of a non-real-time system AMC, assigning burst is performed through empty space of frame at every SS by filling thereat from the back.

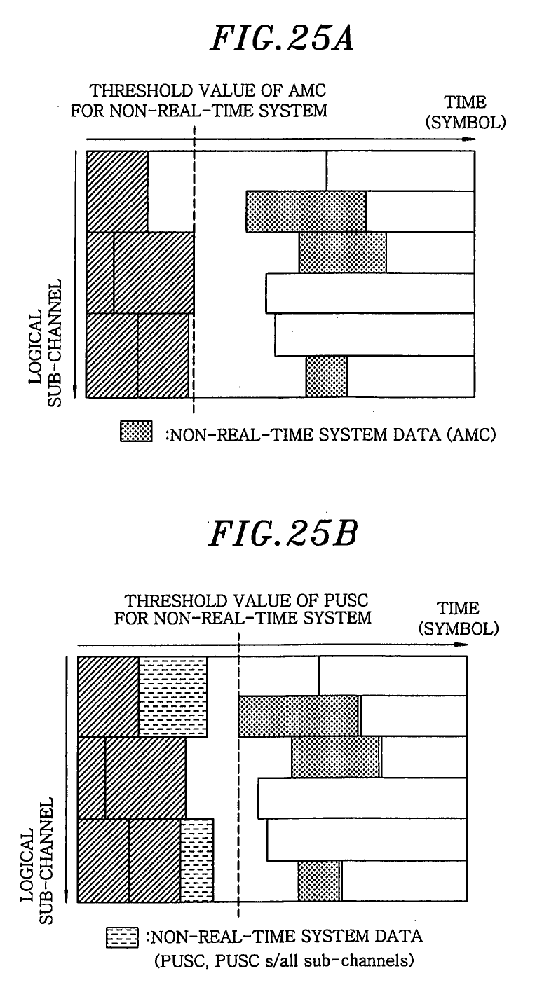

FIG. 25A is an example of mapping real-time system AMC.

To begin with, in S971, a boundary of the real-time system AMC is established based on the total sum of the numbers of symbols, computed in S969, at the zones of PUSC, FUSC, PUSC w/all sub-channels.

Next, in S972, scheduling is performed on the queues which are of SSes for the AMC and belong to the fourth priority QoS category (nrtPS) among the queues for the real-time system, in descending order of the SP values, by using zones where sub-channels allocated to SS remain. After then, in S952, transmitted data is sent to an SB allocated to each user.

Next, in S973, scheduling is performed on the queues which are of SS for the AMC and belong to the fifth priority QoS category (BE) among the queues for the real-time system, in a descending order of the SP values, by using zones where sub-channels allocated to SS remain. After then, in S952, transmitted data is sent to the SB allocated to each user.

Finally in S974, after the scheduling above is finished, the maximum number of the AMC zones is determined from the amount of data stored in the SB allocated to each user.

Returning to FIG. 23, in a next scheduling of the non-real-time system (PUSC, FUSC, PUSC w/ all sub-channels) (S945), assigning burst is performed through forward packing of empty space of each zone.

FIG. 25B is an example of mapping the non-real-time system PUSC, FUSC, PUSC w/ all sub-channels.

At first, in S981, the maximum number of symbols in the PUSC zone is determined from the maximum number of symbols in the AMC zone, computed in S974. As shown in FIG. 25B, a boundary of the non-real-time system PUSC is set to the head of the AMC zone from the maximum number of symbols in the PUSC zone if there is no FUSC or PUSC w/ all sub-channels present, and allocating a PUSC burst beyond the boundary is not allowed.

Next, in S982, scheduling is performed on among queues which are of SS for the PUSC and belong to the fourth priority QoS category in the non-real-time system, in a descending order of the SP values, by using remaining zones, and transmitted data is sent to the SB for the PUSC.

After then, in S983, scheduling is performed on among queues which are of SS for the PUSC and belong to the fifth priority QoS category in the non-real-time system, in a descending order of the SP values, by using remaining zones, and transmitted data is sent to the SB for the PUSC.

Next, in S984, the scheduling of S982 to S983 is performed on the FUSC and transmitted data is sent to an SB for the FUSC.

Next, in S985, the scheduling of S982 and S983 is performed on the PUSC w/ all sub-channels and transmitted data is sent to an SB for the PUSC w/ all sub-channels.

Next, in S987, the number of symbols to be used is computed from an amount of data stored in the SB for the PUSC and the like, and then the maximum numbers of symbols in respective zones and the total sum thereof are computed.

Finally in S988, burst of the AMC zone is packed by forward putting the sum of the number of symbols computed in S987 in the head of the AMC zone. As aforementioned, the burst allocation is adjusted so that burst communications, in each zone, are started from the head, and thus mapping is finished.

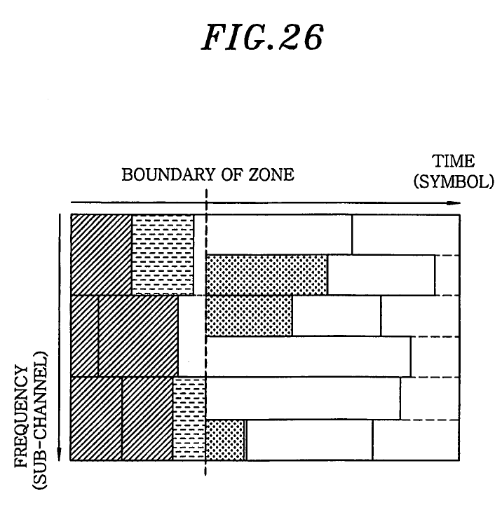

FIG. 26 shows an example of completed mapping through scheduling/mapping process in case of two zones of a PUSC zone and an AMC zone. In the present embodiment, the burst allocation uses a method of a frequency-axis-elongated rectangle for the AMC zone (FIG. 4), and uses a method of a substantially square shape for the PUSC zone. However, the methods of the burst allocation are not limited thereto but may be of an optional allocation such as the ones shown in FIGS. 4 to 6. Further, the SCSB, SISB, MUSB and the like may be used properly as a method of a burst definition.

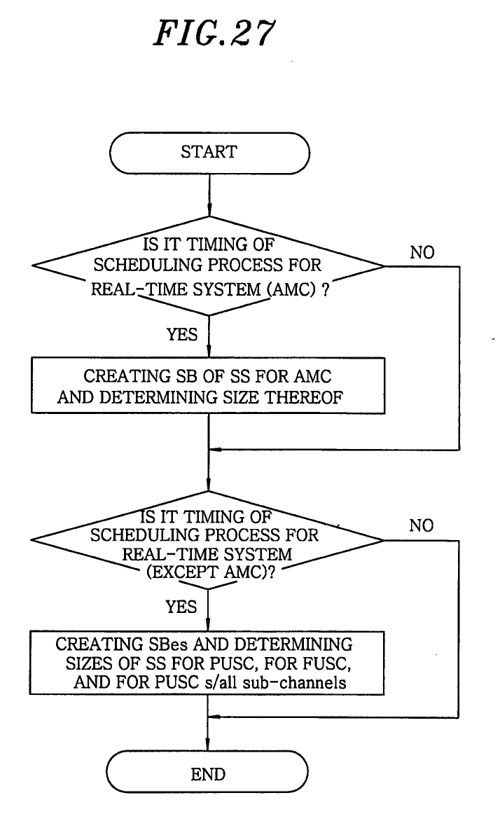

FIG. 27 is a flow chart describing a procedure of an SB control, which is extracted from the scheduling/mapping process aforementioned. As mentioned above, an SB is (logically/physically) divided in every zone in the present embodiment. Further, since the AMC is performed on every SS (user) in the AMC zone, the SB is also divided in every SS (user). The mapping can be performed such that a size is particularly decided to each divided SB and data of queue is copied therein in order to be contained to thereby be contained in the zone.

As aforementioned, in the base station of the present embodiment, the scheduler computes a scheduling priority for every corresponding queue by using QoS parameter decided for every queue (Maximum latency, Minimum reserved Traffic rate, and Tolerated jitter), an elapsed time since a previous lead (as lead to SB, means that packets in queues have been transmitted) of every corresponding queue, an amount of previous transmitted data, previous jitter, modulation level and a coding rate (of burst where corresponding queue is assigned) as input parameters, and by using different functions between the real-time system and the non-real-time system and maintaining the corresponding scheduling priorities as new attribute values of corresponding queue and comparing the corresponding scheduling priority of each queue, transmission sequence of the data packet is controlled. By this, communications quality required for a data stream can be satisfied.

Further, the base station of the present embodiment classifies queues into a real-time system service and a non-real-time system service in accordance with the type (zone) of sub-channel allocation. Further, a data allocation is performed by computing available region for the data allocation in a radio frame structure, in the order of the real-time system and the non-real-time system, and also in the order of sub-channel allocations available for an adaptive modulation and those unavailable for an adaptive modulation. Therefore, scheduling in accordance with QoS and mapping by effectively using radio resources can be performed even though a proper type of sub-channel allocation which is proper to each SS is used.

The present invention is applicable to a wireless communications system.

While the invention has been shown and described with respect to the embodiments, it will be understood by those skilled in the art that various changes and modifications may be made without departing from the scope of the invention as defined in the following claims.

What is claimed is:

1. A wireless base station for mobile stations, comprising:
a queue distributor for distributing packets among queues for a real-time system service and queues for a non-real-time system service and storing the packets;
a scheduler for performing control of transmission sequence of the packets based on the queues for the real-time system service and the non-real-time system service separately;
a buffer for storing the packets therein in the transmission sequence determined by the scheduler; and
a mapper for allocating the packets stored at the buffer among ratio frames.

2. The wireless base station of claim 1, wherein the scheduler uses, for the queues for the real-time system service and for the queues for the non-real-time system service, a same type of algorithm determining the transmission sequence according to priority values determined based on QoS requests and employs different equations to compute the priority values for the real time and the non-real-time system service.

3. The wireless base station of claim 1, wherein the scheduler performs control of transmission sequence such that the queues for the real-time system service are sent prior to the queues for the non-real-time system service.

4. The wireless base station of claim 1, wherein the queue distributor stores the packets separately in accordance with connection IDs at the queues and has tables for making the queues correspond to the QoS parameters including information needed to distinguish between the real-time system service and the non-real-time system service.

5. The wireless base station of claim 2, wherein the scheduler computes a different priority value for each queue depending on whether said each queue belongs to the real-time system and the non-real-time system, and wherein the priority value is expressed by adding and/or multiplying plural functions selected from a group of functions, which includes a latency function, a service class function, a quality function of wireless communications between the wireless base station and a corresponding mobile terminal, a function of an elapsed time since a previous transmission of said each queue, and a function of the number of transmissions.

6. The wireless base station of claim 1, further comprising a receiver for receiving information of wireless communications quality measured by a mobile terminal and measuring a Doppler frequency of a radio signal from the mobile terminal, wherein the scheduler controls at least one of sub-channel allocation, modulation method, and coding rate based on the information of wireless communications quality and the Doppler frequency.

7. The wireless base station for transmitting and receiving real-time system and non-real-time system packets to and from a plurality of subscriber stations, at an IP layer level, comprising:
a queue distributor for distributing packets to be transmitted among plural queues and storing therein data of the packets to be transmitted; and
a scheduler for computing, a scheduling priority for each queue by using different functions depending on whether said queue belongs to the real-time system or the non-real-time system and sending the queues according to magnitudes of their scheduling priorities, wherein input parameters of the functions include a maximum latency, a minimum reserved traffic rate, a tolerable jitter amount, an elapsed time since a previous transmission, a data amount in the previous transmission, previous jitter, a modulation level, and a coding rate for said each queue.

8. The wireless base station of the claim 7, wherein the wireless base station is used in an OFDMA system and further comprises a mapper for classifying each of the queues of the real-time system and the non-real-time system into one of different sub-channel allocation types, and determining a data allocation while computing an amount of allocatable data into sub-channel allocation zones corresponding to a radio frame, in an order of the real-time system and the non-real time system, and also in an order of sub-channel allocation capable of adaptive modulation and sub-channel allocation incapable of adaptive modulation.
